(19) United States
(12) Patent Application Publication
(10) Pub. No.: US 2003/0234589 A1
(43) Pub. Date: Dec. 25, 2003

(54) Rotor limiter for fluid dynamic bearing motor

(76) Inventors: Norbert Steven Parsoneault, Scotts Valley, CA (US); Robert Alan Nottingham, Santa Cruz, CA (US); Alan Lyndon Grantz, Aptos, CA (US); Michael Ray Tiller, Santa Cruz, CA (US); Jeffry Arnold LeBlanc, Aptos, CA (US); Troy Michael Herndon, San Jose, CA (US); Michael James Whittome, Scotts Valley, CA (US); Chris Woldemar, Santa Cruz, CA (US)

Correspondence Address: James A. Sheridan, Moser, PATTERSON& SHERIDAN, L.L.P., 575 SHREWSBURY AVENUE, SUITE 100, SHREWSBURY, NJ, 07702, US

(21) Appl. No.: 10/600,096

(22) Filed: Jun. 20, 2003

Related U.S. Application Data
(60) Provisional application No. 60/390,382, filed on Jun. 21, 2002.

(51) Int. Cl. H02K 5/16

(52) U.S. Cl. 310/90

(57) ABSTRACT

A motor is provided comprising a rotor, a stationary sleeve disposed about the rotor, a fluid dynamic bearing between the rotor and sleeve, and a limiter for restricting axial movement of the rotor relative to the stationary sleeve.

### CROSS REFERENCE TO RELATED APPLICATIONS

This application claims the priority of United States Provisional Application No. 60/390,382, filed Jun. 21, 2002 by Parsoneault et al. (entitled “Rotor Limiter for FDB Motor”), which is herein incorporated by reference.

### FIELD OF THE INVENTION

The invention relates to fluid dynamic bearing motors, and more specifically to fluid dynamic spindle motors with limited axial movement.

### BACKGROUND OF THE INVENTION

Disk drives are capable of storing large amounts of digital data in a relatively small area. Disk drives store information on one or more recording media, which conventionally take the form of circular storage disks (e.g. media) having a plurality of concentric circular recording tracks. A typical disk drive has one or more disks for storing information. This information is written to and read from the disks using read/write heads mounted on actuator arms that are moved from track to track across the surfaces of the disks by an actuator mechanism.

Generally, the disks are mounted on a spindle that is turned by a spindle motor to pass the surfaces of the disks under the read/write heads. The spindle motor generally includes a shaft and a hub, to which one or more discs are attached, and a sleeve defining a bore for the shaft. Permanent magnets attached to the hub interact with a stator winding to rotate the hub and disc. In order to facilitate rotation, one or more bearings are usually disposed between the sleeve and the shaft.

Over the years, storage density has tended to increase, and the size of the storage system has tended to decrease. This trend has lead to greater precision and lower tolerance in the manufacturing and operating of magnetic storage disks.

From the foregoing discussion, it can be seen that the bearing assembly that supports the hub and storage disk is of critical importance. One typical bearing assembly comprises ball bearings supported between a pair of races that allow a hub of a storage disk to rotate relative to a fixed member. However, ball bearing assemblies have many mechanical problems, such as wear, run-out and manufacturing difficulties. Moreover, resistance to operating shock and vibration is poor because of low damping.

One alternative bearing design is a fluid dynamic bearing. In a fluid dynamic bearing, a lubricating fluid such as air or liquid provides a bearing surface between a fixed member of the housing and a rotating member of the disk hub. In addition to air, typical lubricants include gas, oil, or other fluids. Fluid dynamic bearings spread the bearing surface over a large surface area, as opposed to a ball bearing assembly, which comprises a series of point interfaces. This is desirable because the increased bearing surface reduces wobble or runout between the rotating and fixed members. Further, the use of fluid in the interface area imparts damping effects to the bearing, which helps to reduce non-repeatable run-out.

One embodiment of a fluid dynamic bearing motor is magnetically biased. That is, the bearing design cooperates with a magnetically biased circuit or element to establish and maintain fluid pressure in the bearing areas, especially in designs where the thrust bearing is defined in the gap at the end of the shaft. This eliminates the need to provide hydrodynamic grooves on one or more motor elements in order to accomplish the same, which in turn reduces the power consumed by the motor. However, this means that the only thing holding the rotating portion of the motor in place is the axial magnetic force; therefore, if under shock axial forces exceed magnetic forces in the motor, the rotor can shift and the disk drive will fail.

Therefore, there is a need for a fluid dynamic spindle motor in which axial movement of the rotor is restricted.

### SUMMARY OF THE INVENTION

The invention is a motor comprising a rotor, a stationary sleeve disposed about the rotor, a fluid dynamic bearing between the rotor and sleeve, and a limiter for restricting axial movement of the rotor relative to the stationary sleeve.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a plan view of one embodiment of a disk drive having a motor in accordance with the present invention;

FIG. 2 is a vertical sectional view depicting a magnetically biased fluid dynamic spindle motor according to one embodiment of the present invention;

FIG. 3 is a vertical sectional view depicting a magnetically biased fluid dynamic spindle motor according to a second embodiment of the present invention;

FIG. 4 is a vertical sectional view depicting a magnetically biased fluid dynamic spindle motor according to a third embodiment of the present invention; and

FIG. 5 is a vertical sectional view depicting a magnetically biased fluid dynamic spindle motor according to a fourth embodiment of the present invention.

FIG. 6 is a vertical sectional view of a motor embodying a further embodiment of the present invention.

FIG. 7 is a vertical sectional view of a rotating shaft motor embodying a further embodiment of the invention.

FIGS. 8A and 8B are partial vertical sectional view and an exploded view of another embodiment of the limiter used in a fixed shaft motor.

FIG. 9 is an exploded view of a limiter useful in the embodiment of FIG. 8A.

FIGS. 10A and 10B are a partial vertical sectional view and an exploded view of a stationary shaft motor incorporating an alternative embodiment of the present invention.

FIG. 11A is a vertical sectional view of a limiter useful in a rotating shaft motor such as shown in FIG. 6; FIGS. 11B and 11D are plan views of the limiter shown in FIG. 11A; and FIG. 11C is a cross-sectional view of the limiter of FIGS. 11B and 11D;

And FIGS. 12A and 12B are partial vertical sectional views alternate embodiments of a limiter especially useful with a rotating shaft motor.

To facilitate understanding, identical reference numerals have been used, where possible, to designate identical elements that are common to the figures.

### DETAILED DESCRIPTION

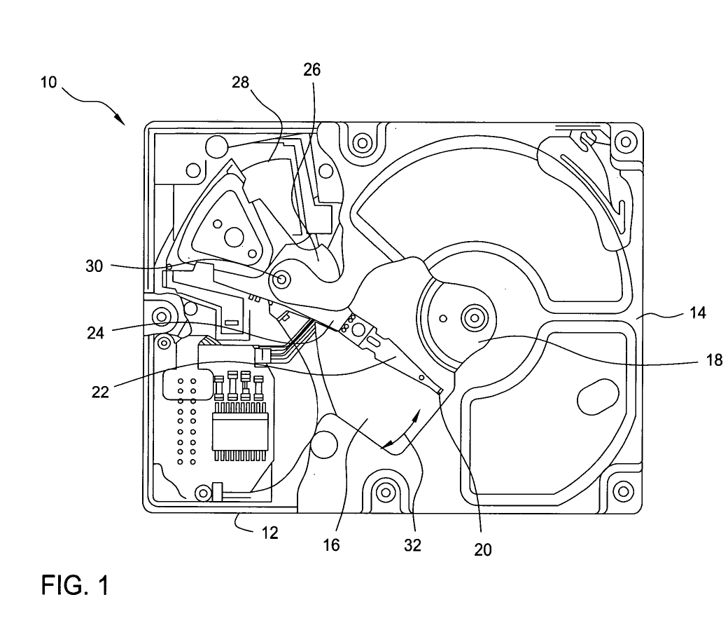

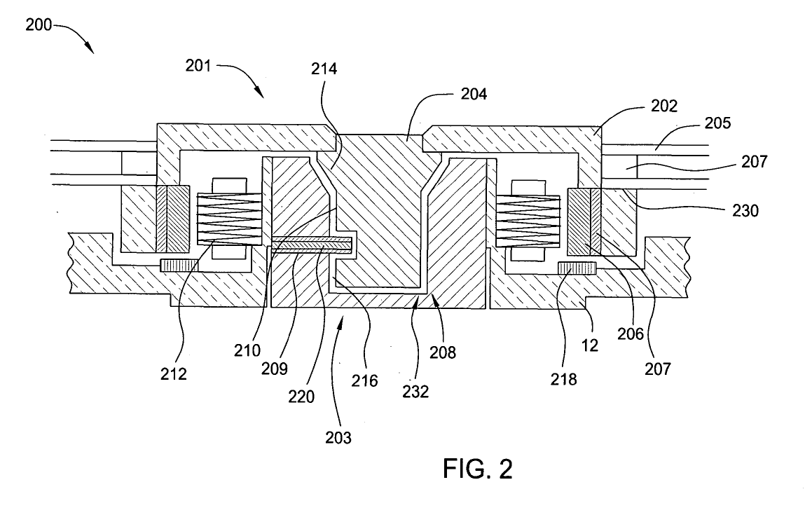

FIG. 1 depicts a plan view of one embodiment of a disk drive 10 for use with embodiments of the invention. Referring to FIG. 1, the disk drive 10 includes a housing base 12 and a top cover 14. The housing base 12 is combined with top cover 14 to form a sealed environment to protect the internal components from contamination by elements outside the sealed environment. The base and top cover arrangement shown in FIG. 1 is well known in the industry; however, other arrangements of the housing components have frequently been used, and aspects of the invention are not limited by the particular configuration of the disk drive housing. Disk drive 10 further includes a disk pack 16 that is mounted on a hub 202 (see FIG. 2) for rotation on a spindle motor (not shown) by a disk clamp 18. Disk pack 16 includes one or more of individual disks that are mounted for co-rotation about a central axis. Each disk surface has an associated read/write head 20 that is mounted to the disk drive 10 for communicating with the disk surface. In the example shown in FIG. 1, read/write heads 20 are supported by flexures 22 that are in turn attached to head mounting arms 24 of an actuator 26. The actuator shown in FIG. 1 is of the type known as a rotary moving coil actuator and includes a voice coil motor (VCM), shown generally at 28. Voice coil motor 28 rotates actuator 26 with its attached read/write heads 20 about a pivot shaft 30 to position read/write heads 20 over a desired data track along a path 32.

FIG. 2 is a vertical sectional view of one embodiment of a magnetically biased fluid dynamic bearing spindle motor 200 according to the present invention.

The motor 200 includes a base 12 and a rotating assembly 201 comprising a hub 202 mounted to a shaft 204 for rotatably supporting one or more disks 205. The rotating assembly 201 further comprises a magnet 206 affixed to back iron 207. The hub 202 comprises a disk-mounting flange 230 that supports one or more disks 205 and disk spacers 207, if necessary.

A stationary assembly 203 comprises a sleeve 208 with a recess 210 defined therethrough to receive the shaft 204. Mounted upon the sleeve 208 is a stator 212 that, when energized, communicates with the magnet 206 in the hub 202 and, when the stator 212 is energized, induces rotation of the shaft 204 and hub 202 about the stationary sleeve 208. The stator 212 comprises a plurality of “teeth” 215 formed of a magnetic material where each of the teeth 215 is wound with a winding or wire 217.

A bearing assembly 232 is further provided for stable rotational support of the shaft 204 and hub 202 relative to the stationary sleeve 208. A hydrodynamic bearing on the rotating assembly—here shown as a conical bearing 214 integrally formed with the shaft 204—together with a bearing on the bore of the stationary journal sleeve 208, forms a bearing surface. Alternatively, journal bearings may be formed on the outer surface of the shaft 204 and the bore of the journal sleeve 208 by grooving the facing surfaces. Fluid 216 such as oil, air, or gas is introduced between the outer surface of the shaft 204 and the bore of the journal sleeve 208. Additionally, grooved surfaces on a thrust or counterplate (not shown in the figure) may provide additional bearing surfaces.

To establish and maintain pressure in the fluid 216, and to bias the rotating assembly, a constant force magnetic circuit is provided comprising a magnet 206 supported on the rotating assembly (here mounted on the hub 202), located across a gap from a magnetically conducting steel ring 218 supported on the stationary assembly (here mounted on the base 12). Other magnetic circuits or placements are of course possible. Such a configuration recognizes many advantages; however, a significant disadvantage to magnetically biased fluid dynamic bearing motors of the prior art is that the axial magnetic force is the only force holding the rotating assembly in place in the motor. If other axial forces such as a shock should exceed the magnetic force, then the rotating assembly will fall out of the motor, and the disk drive will fail.

It is therefore the aim of the present invention to restrict the axial movement of the rotating assembly by means other than the axial magnetic forces acting alone. One embodiment of the invention is limiter pin 220, which is mounted, for example by press fitting or epoxy, into a bore 209 in the stationary sleeve 208. Limiter pin 220 protrudes at an angle substantially perpendicular to the hub 202, from approximately the midpoint of the sleeve 208 and into an annular recess 222 on the outer surface of the shaft 204. The annular recess 222 is defined by a decreased diameter on the shaft surface and has a depth of, for example, one quarter of the shaft diameter. The width of the recess 222 on the shaft surface dictates the extent to which the shaft 204 may move axially when engaged by the limiter pin 220.

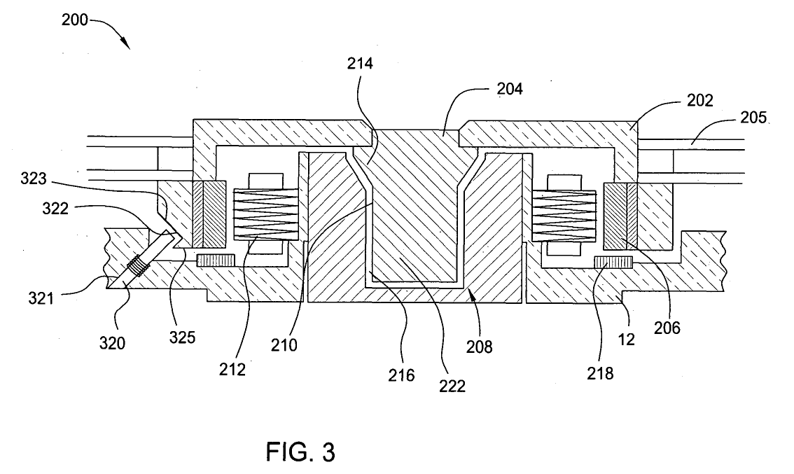

In another embodiment (shown in FIG. 3), a limiter screw 320 is screwed into a threaded bore 321 in the base 12. Alternatively, the screw 320 could be epoxied or press fit into the bore 321. In one embodiment, the limiter screw 320 protrudes from the base 12 at an angle of approximately 45 degrees and extends into a recess 322 defined by an annular, angular cut on a lower portion of the hub's outer surface. The recess 322 is cut at an angle of approximately 45 degrees from a bottom surface 325 of the hub 202 and comprises a face 323 that is substantially parallel to an end of the screw 320. Alternatively, the screw 320 could extend at an angle substantially perpendicular to the outer surface of the hub 202, into a recess 322 that is substantially perpendicular to the shaft 204. As in FIG. 2, the depth of the recess 322 defines the axial range in which the hub 202 is free to move.

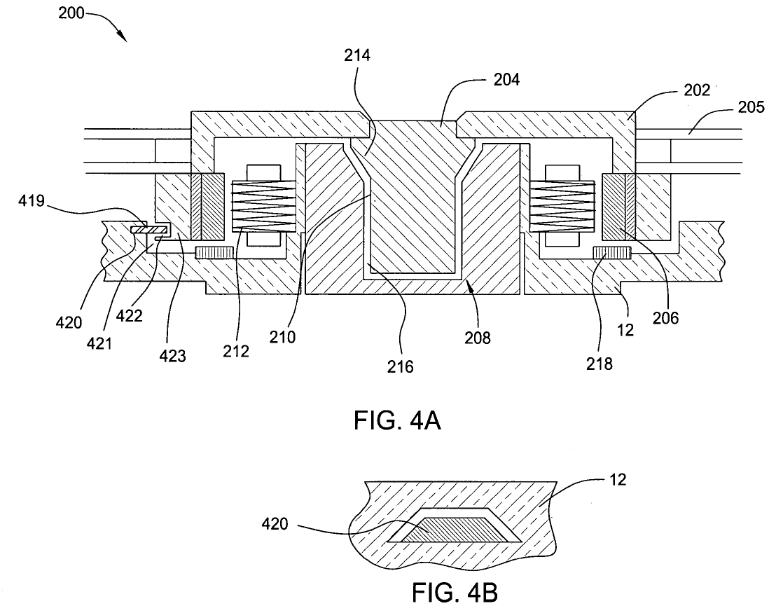

In yet another embodiment (shown in FIGS. 4A and B), a limiter block 420 is mounted, for example by press fit or epoxy, into a bore 419 in the base 12 and extends at an angle substantially perpendicular to the hub 202. Limiter block 420 protrudes from a portion of the base 12 located across a gap 421 from a lower portion 423 of the hub 202. Limiter block 420 extends into an annular recess 422 defined in the lower portion 423 of the hub 202 by a decreased diameter on the outer hub surface. Limiter block 420 is, for example, trapezoidal in shape as shown in FIG. 4B, but may admit to other equally effective geometries. As in FIGS. 2 and 3, the width of the recess 422 defines the axial range in which the hub 202 is free to move.

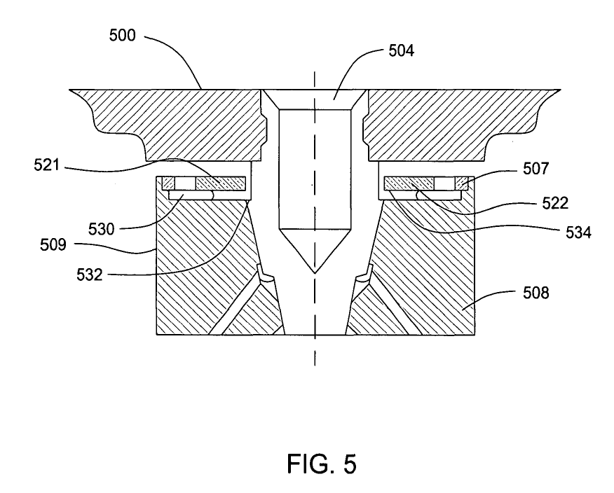

FIG. 5 represents an alternate embodiment of a limiter comprising a flange 522 on the upper portion 507 the stationary sleeve 508. The flange 522 and sleeve 508 define a capillary seal (here a centrifugal capillary seal) 530 therebetween to prevent fluid from escaping the motor 500. The flange 522 is substantially perpendicular to the shaft 504 and extends inward from an outer surface 509 of the sleeve 508. The end 521 of the flange 522 extends over a lip 532 that extends around the circumference of the shaft 504. The lip 532 is defined by a decrease in the diameter of the upper portion of the shaft 504. The distance between the lip 532 on the shaft 504 and the lower edge 534 of the flange 522 defines the axial range in which the shaft 504 is free to move.

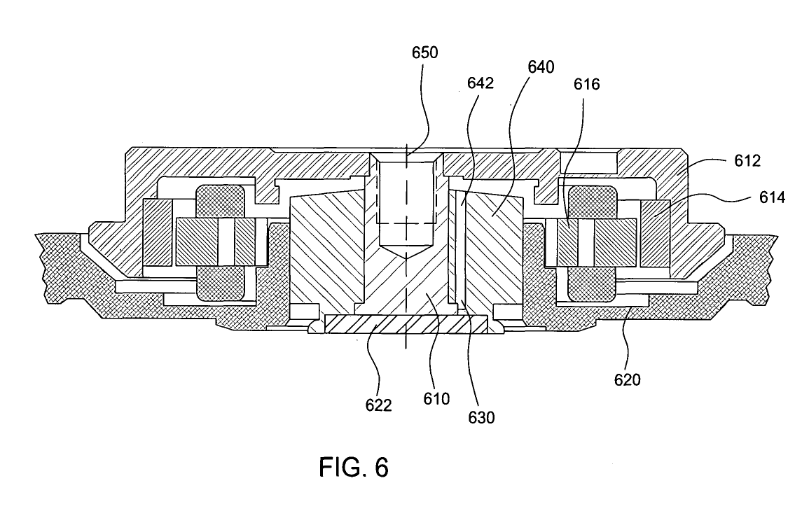

A further alternative embodiment is shown in FIG. 6 which is a motor with a rotating shaft 610 supporting a hub 612. Rotation of the motor is caused by the interaction between the magnet 614 and the stator 616, the magnet being support from the hub 612 and the stator from the base 620. An axial electromagnetic bias is established by an axial offset of the magnet 614 from the stator 616. The limiter in this embodiment comprises a step 630 defined at an end of the shaft closest to the base 620 or counterplate 622. This step 630 may be either integrated with the shaft 610 or be press fit thereon. The step extends axially a limited distance under the sleeve 640 which is supported from the base 620 and in turn supports the counterplate 622. As shown, it may extend at least part way into the recirculation path 642 which is defined axially through the shaft 640; typically, there is grooving on one of the end of the shaft 610 or the facing surface of counterplate 622 to drive fluid toward the center axis 650 of the shaft causing any air bubbles to move toward the outer edge of the shaft and step 630 and then into the recirculation path; therefore this intrusion of the step into the recirculation path does not hinder the successful operation on this embodiment.

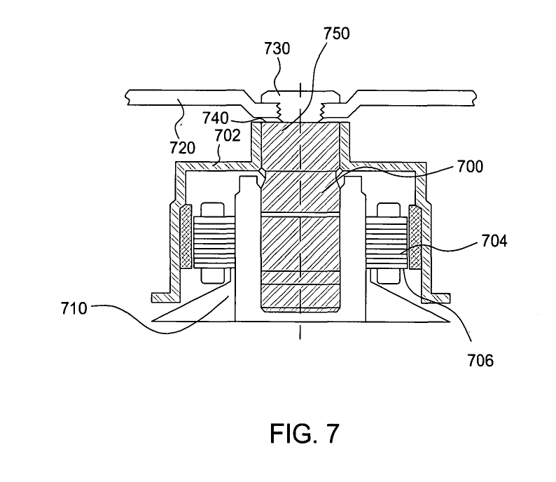

FIG. 7 shows an alternative embodiment wherein as before, a rotating shaft 700 supports a hub 702 for rotation supporting one or more disks. The hub supports a magnet 704 on its interior surface, generally aligned with but in this embodiment axially offset from a stator 706. In this embodiment, the motor is shown supported from a base 710 of a disc drive, and within and below a top cover 720 of the housing for the disc drive. According to this approach, a screw 730 is threaded through the cover 720, and just out of contact with a top surface 740 of the shaft. The distance between the bottom surface 750 of the screw 730 and the upper surface 740 of the shaft 700 sets the limit of travel under sharp conditions and the like for the shaft. Thus, in a very straight forward fashion the system is guaranteed against unnecessary disengagement or misalignment of the shaft from the sleeve.

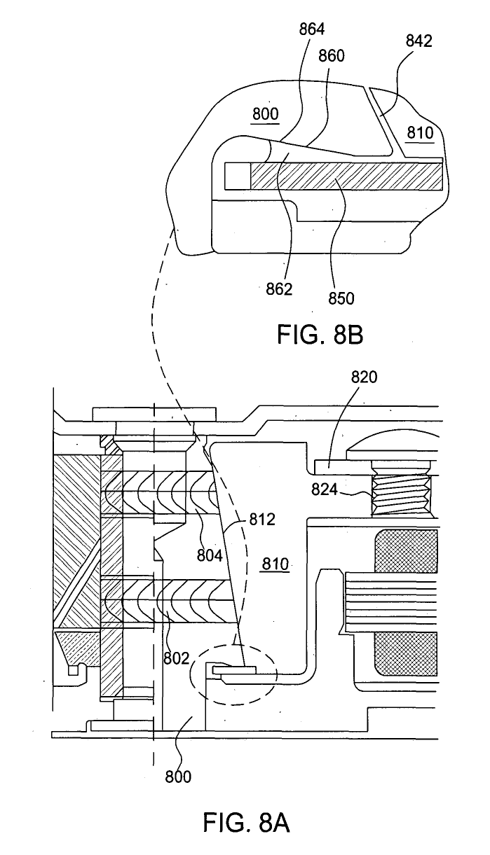

FIG. 8A is a partial sectional view of a stationary shaft motor cooperating with a limiter supported from the surrounding sleeve, and FIG. 8B, is an exploded view of a section of the same design. A stationary shaft 800 has two sets of grooves 802, 804 spaced axially along the shaft which form a fluid dynamic bearing for supporting the sleeve 810 for rotation around the shaft. This support is provided by fluid 812 which lies in the gap between the surface of the shaft 800 and the surface of the sleeve 810 and is pressurized by the grooves to form a support for the rotating sleeve.

One or more disks (not shown) are supported from an outer surface of the hub 810 and are held in place using a clamp 820 which is screwed or otherwise fastened to the hub 810 by screw 824. Also not shown, magnetic biasing is established, preferably by axially offsetting the magnet and stator which cause rotation of the hub similar to FIGS. 6 and 7.

To prevent axial disengagement of the hub from the stationary shaft, a limiter 850 which is shown especially clearly in the enlarged view in FIG. 8B is fastened with adhesive or by welding or any other useable fastening system to the sleeve 810. The limiter 850 extends axially beneath a shoulder 860 defined on the shaft 800. The gap 842 between the rotor 810 and the shaft 800 continues between the upper surface 862 of the limiter 850 and the facing surface 864 of the shoulder 860. The surfaces 862, 864 diverge axially, thereby forming a radial capillary seal between the fixed shaft and the rotating hub to retain the fluid in the gap 842 which supports the relative rotation. Thus, dual benefits are achieved by the limiter design of FIGS. 8A and 8B.

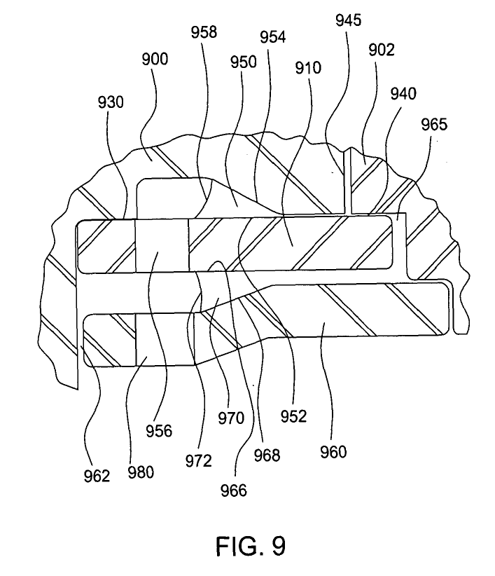

A further alternative embodiment is shown in FIG. 9. FIG. 9 shows a variation on the embodiment of FIG. 8 wherein the limiter 910 is supported from the stationary shaft 900 within the rotating sleeve 902. In this embodiment, the limiter 910 is supported from the shoulder 930 of the shaft 900 and extends radially underneath the shoulder 930 and under a shoulder 940 of sleeve 902. As with other embodiments, to support relative rotation of the shaft and sleeve, a fluid filled gap 945 is provided between the shaft and sleeve, with grooves on one of the surfaces that define the gap 945 pressurizing the fluid to support the smooth rotation in order to maintain the fluid in the gap 945. A reservoir 950 is defined by the facing and axially diverging surfaces of the limiter 910 and the shaft 900. This is most easily achieved by providing a flat axial surface 952 on the limiter 910, and an axially diverging surface 954 facing the limiter across the reservoir. An air opening 956 is also provided comprising one or more openings cut through the limiter in an axial direction to support the formation of the meniscus 958 which is the end of the fluid filled gap and maintains the fluid within the gap. In a further modification, in this embodiment a limiter shield 960 is provided supported from the rotating sleeve 902 and extending generally radially toward the shaft, ending across a small air gap 962 from the shaft. This limiter shield is provided so that a fluid gap can extend around the surface of the limiter 910 where it underlies the sleeve 902 so that the fluid in this gap 965 will support relative rotation of the limiter and the sleeve. The gap 965 must extend around the limiter past the radial and axially facing surfaces of the sleeve and then between the limiter and the limiter shield 960 in order to provide an appropriate termination for the fluid in the gap. The surfaces 966, 968 of the limiter and shield respectively diverge as shown, provided another oil reservoir 970 ending in a meniscus 972. An air opening 980 should also be provided though the limiter into the gap between the limiter and the limiter shield to support establishment and maintenance of the meniscus 972.

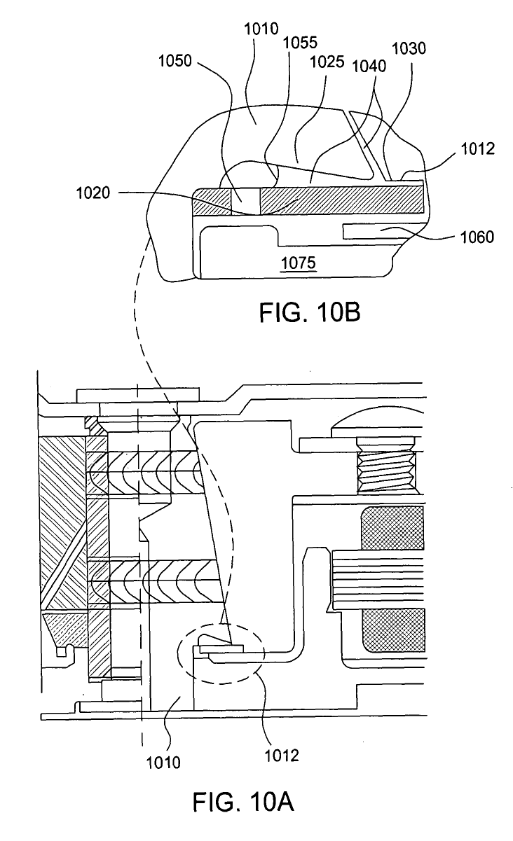

A further alternative embodiment and a variation on the embodiment of FIG. 9 is shown in FIG. 10A and 10B. FIG. 10A shows a stationary shaft 1010 surrounded by a rotating sleeve 1012. As with FIGS. 8 and 9, a limiter is supported from the shaft 1010, details of which are shown in the enlarged view of FIG. 10B. The embodiment of FIG. 10B shows a limiter 1020 supported from and extending radially from the base 1010, spaced underneath a shoulder 1025 of the shaft 1010 and extending underneath a shoulder 1030 of the sleeve 1012. As with the preceding embodiment, the fluid filled gap 1040 between the shaft and the sleeve is extended radially in both directions, to both surround the radial end of the limiter 1020 and to extend inwardly toward the central axis to end in a reservoir 1040. One or more openings 1050 are formed through the limiter 1020 to aid in the formation of the meniscus 1055 at the end of the reservoir 1040.

According to this embodiment, a secondary limiter 1060 extends radially inwardly from the sleeve 1012 and axially beneath the shaft supported limiter 1020. Both of these limiters are placed above the base 1075 so that the limiter 1020 intervenes between the sleeve limiter 1060 and the shoulder 1030 of the sleeve. In this way, the limiter 1020 is held securely below the rotating sleeve 1012 and above the sleeve supported limiter 1060 so that it is very difficult for the sleeve to move axially under shock in either direction relative to the shaft.

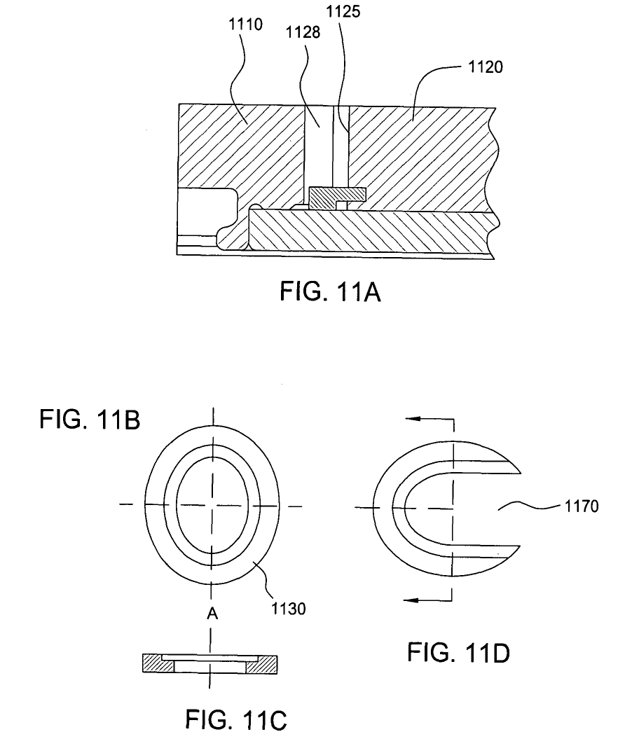

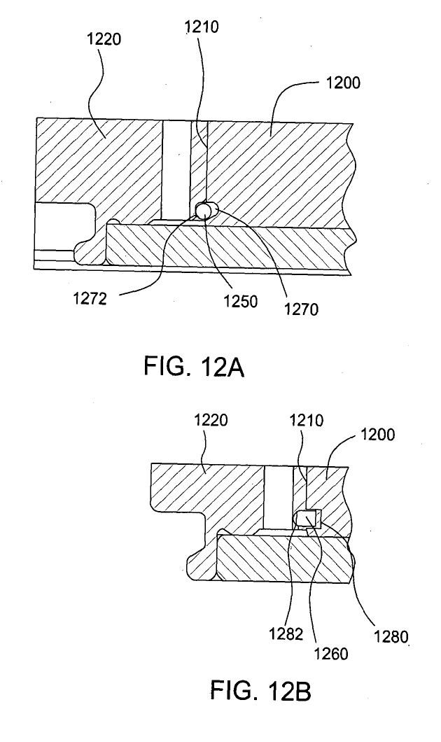

FIGS. 11A, B, and C show alternative approaches to capturing the axial location of the shaft relative to the sleeve in a motor such as shown in FIG. 6. Specifically, referring to FIG. 11A, we see a sleeve 1110 and a shaft 1120 rotating within the bore 1125 defined by the sleeve 1110. A recirculation path as previously described in FIG. 6 provides for fluid recirculation within the system. To hold the shaft axially in place under shock conditions, a retaining ring such as shown in FIG. 11B or 11D is provided, with 11D being a sectional view along the line AA of the ring 1130 shown in FIG. 11B. The ring is especially useful for this function because as clearly appears in FIGS. 11B and 11C, it is a part which is easily installed and inexpensive to fabricate, and comprises a floating design which is not necessarily connected to the shaft or hub. The ring is simply an L shaped cross section as appears in FIG. 11C, is designed for the ring to both rest on the counterplate 1140 and to be of a sufficient radial extent to extend into a slot or groove 1150 in the shaft. Thus, the retaining ring lends itself to a simple assembly by virtual of putting the shaft 1120 into the bore 1125 of the sleeve 1110 with the two sections of the ring 1130 inserted into the shaft recess 1150 from either side, and the counterplate 1140 then being wedged, welded or otherwise fastened in place. Thereby capturing the shaft axially using the ring sections 1130.

In an alternative embodiment, the ring 1135 (FIG. 11D) may be used, Although the assembly sequence would be substantially the same, this offers the benefit of providing the slot 1170 on one side which can be oriented to the return hole 1128. By using this approach, the chance of any interference with the free flow of the lubricating fluid from the opening 1125 between the sleeve and the shaft to the return hole 128 as known in the art is diminished.

Yet another alternative as shown in. FIGS. 12A and 12B. In both of these figures, the shaft 1200 is shown inserted in a bore 1210 defined by a sleeve 1220. In both FIGS. 12A and 12B, a flexible ring 1250 or 1260 is provided. The difference in the two embodiments is that the ring 1250 in FIG. 12A is circular in cross section; the ring 1260 of FIG. 12B is generally rectangular. Referring specifically to 12A, it can be seen that there is a groove 1270 in the outer surface of the shaft 1200 which is roughly similar in cross section to the outer surface of the ring 1250 so that the ring may be compressed into the groove while the shaft slides through the sleeve 1220. When it reaches a locking groove 1272, the ring snaps in place, being lodged partly in the locking groove 1272 and partly in the groove 1270 of the shaft thereby holding the shaft axially in place. The design of the embodiment of FIG. 12B is similar, with the ring 1260 being compressed into the generally rectangular groove 1280, and then snapping into place in the slot 1282 of sleeve 1220.

Therefore, the present invention accomplishes the task of restricting axial movement of the rotating assembly in a magnetically biased fluid dynamic bearing motor. The advantages of such a motor may exploited despite the presence of axial forces that may exceed magnetic forces in the motor.

While the foregoing is directed to embodiments of the invention, other and further embodiments of the invention may be devised without departing from the basic scope thereof, and the scope thereof is determined by the claims that follow.

What is claimed is:

1. A fluid dynamic bearing motor comprising:
a rotor;
a stationary sleeve disposed about a portion of the rotor and mounted to a base;
a stator mounted to the stationary sleeve;
a fluid dynamic bearing between the rotor and stationary sleeve; and
a limiter for restricting axial movement of the rotor with respect to the stationary sleeve.

2. The fluid dynamic bearing motor of claim 1, wherein a portion of the rotor cooperating with the limiter comprises a shaft rotating within the stationary sleeve.

3. The fluid dynamic bearing motor of claim 2, wherein the rotor further comprises:
a hub rotatably supported by the shaft; and
a rotor magnetic assembly affixed to the hub.

4. The fluid dynamic bearing motor of claim 3, wherein the rotor is adapted to support at least one disk.

5. The fluid dynamic bearing motor according to claim 4, wherein the limiter comprises an element that protrudes into or from a surface of the hub.

6. The fluid dynamic bearing motor according to claim 5, wherein the element is selected from a group consisting of a screw, a pin, a block, and a flange.

7. The fluid dynamic bearing motor according to claim 6, wherein the limiter comprises an element that protrudes from a stationary member and into a recess in the rotor.

8. The fluid dynamic bearing motor according to claim 5, wherein the element comprises a pin that protrudes from the stationary sleeve and into a recess in the shaft.

9. The fluid dynamic bearing motor according to claim 5, wherein the element comprises a screw that protrudes from the base and into a recess in an outer diameter of the hub.

10. The fluid dynamic bearing motor according to claim 5, wherein the element comprises a block that protrudes from the base and into a recess in an outer diameter of the hub.

11. The fluid dynamic bearing motor according to claim 10, wherein the block is trapezoidal in shape.

12. The fluid dynamic bearing motor according to claim 5, wherein the element comprises a flange that extends from the stationary sleeve and into a recess in the shaft.

13. The fluid dynamic bearing motor according to claim 12, wherein the recess in the shaft is defined by a portion of the shaft having a decreased diameter that allows the flange to extend over a lip on the shaft.

14. The fluid dynamic bearing motor according to claim 13, wherein a capillary seal is defined between the flange and the stationary sleeve.

15. The fluid dynamic bearing motor according to claim 14, wherein the capillary seal is a centrifugal capillary seal.

16. A fluid dynamic bearing motor comprising:
a stator;
rotor means disposed proximate the stator, for rotating upon the stator being energized;
bearing means, between said stator and rotor means, for enabling the rotor means to rotate relative to the stator; and
limiter means for restricting axial movement of the rotor means with respect to the stator.

17. The fluid dynamic bearing motor of claim 16, wherein the rotor means further comprises:
a shaft;
a hub rotatably supported by the shaft; and
a rotor magnetic assembly affixed to the hub.

18. The fluid dynamic bearing motor according to claim 17, wherein the limiter means comprises an element that protrudes into or from a surface of the hub.

19. The fluid dynamic bearing motor according to claim 18, wherein the element comprises at least one of the following: a screw, a pin, a block, or a flange.

20. A disk drive comprising:
a hub for rotatably supporting at least one disk;
a shaft affixed to and disposed through the center of the hub;
a stationary sleeve disposed about the shaft;
a fluid dynamic bearing between the shaft and the sleeve;
a stator affixed to the sleeve;
a magnet assembly affixed to the hub; and
a limiter for restricting axial movement of the hub with respect to the sleeve.

21. A fluid dynamic bearing as claimed in claim 20 wherein the limiter comprises a step on an end of the shaft adjacent a counterplate supported from the sleeve.

22. A disk drive as claimed in claim 21 wherein the step is integral with the shaft.

23. A disc drive as claimed in claim 21 wherein the step comprises a circular disk fixed to an end of the shaft.

24. A disc drive as claimed in claim 23 wherein the magnet is offset from the stator to provide an axial bias to the shaft to aid in supporting the axial location of the shaft.

25. A disc drive as claimed in claim 20 wherein the sleeve is supported from a base, and further comprising a top cover, and a screw threaded through the top cover into contact with an upper surface of the shaft, the threading of the screw being established to define a limit of axial travel of the shaft and the hub relative to the base and the sleeve.

26. A disc drive as claimed in claim 25 wherein the magnet is offset from the stator to provide an axial bias to the shaft to aid in supporting the axial location of the shaft.

27. A fluid dynamic bearing motor as claimed in claim 1 wherein the rotor includes a shaft extending through a bore defined by the sleeve, and the limiter comprises a U-shaped element extending into a groove in the shaft and axially restrained by the sleeve.

28. A fluid dynamic bearing motor as claimed in claim 27 wherein the limiter is further axially restrained by a counterplate supported from the sleeve and having a surface facing an end surface of the shaft.

29. A fluid dynamic bearing motor as claimed in claim 26 wherein the limiter is a split ring comprising first and second sections, the sections being radially inserted into a groove in the sleeve and restrained in place axially by the sleeve.

30. A fluid dynamic bearing motor as claimed in claim 26 wherein the limiter comprises a ring supported and extending partially into a groove in the shaft and further extending partially radially into a groove in the sleeve to capture the shaft against axial movement relative to the sleeve.

31. A fluid dynamic bearing motor as claimed in claim 30 wherein the groove in the sleeve is similar in cross section to the an external surface of the ring, the ring being compressible into the groove so that the shaft may be inserted into the sleeve.

32. A fluid dynamic bearing motor as claimed in claim 26 wherein the limiter comprises a U-shaped ring extending partially into a groove in the shaft and further extending partially radially into a groove or opening in the sleeve to capture the shaft against axial movement relative to the sleeve, an opening in the U-shaped ring being aligned with a recirculation path in the sleeve.

33. A fluid dynamic bearing motor as claimed in claim 31 wherein the ring is circular or rectangular in cross section.

34. A fluid dynamic bearing motor comprise a stationary shaft supported from a base, a sleeve supporting a hub which in turn is adapted to support one or more discs for rotation, grooves on one of the facing surfaces of the shaft or sleeve, fluid in a gap defined between the shaft and sleeve for supporting rotation of the sleeve around the shaft, and a limiter supported from the sleeve and extending beneath a shoulder of the stationary shaft for limiting axial travel of the sleeve relative to the shaft.

35. A fluid dynamic bearing motor as claimed in claim 34 wherein a surface of the shoulder of the shaft axially diverges from a surface of the limiter, the gap between the sleeve and the shaft communicating with the gap between the shoulder and the limiter so that a reservoir may be defined between the limiter and the shoulder of the shaft.

36. A fluid dynamic bearing motor as claimed in claim 35 wherein the limiter is closely adjacent a surface of the base so that a seal is defined between the reservoir and the limiter and the sleeve and the limiter to prevent any loss of fluid from the reservoir into surrounding atmosphere.

37. A fluid dynamic bearing motor as claimed in claim 35 further including a limiter shield axially displaced from the shoulder of the shaft and the limiter supported from the shaft, the limiter shield being supported from the sleeve and rotating therewith to further reliably seal the fluid bearing from the outside atmosphere.

38. A fluid dynamic bearing as claimed in claim 37 wherein the limiter shield includes an axial surface which axially diverges from a surface of the limiter in order to establish a fluid reservoir communicating with a gap of the fluid bearing.
